(19) United States
(12) Patent Application Publication
(10) Pub. No.: US 2013/0327061 A1
(43) Pub. Date: Dec. 12, 2013

(54) TURBOMACHINE BUCKET ASSEMBLY AND METHOD OF COOLING A TURBOMACHINE BUCKET ASSEMBLY

(71) Applicants: Biju Nanukuttan, Bangalore (IN); Joshy John, Bangalore (IN); Herbert Chidsey Roberts, III, Simpsonville, SC (US)

(72) Inventors: Biju Nanukuttan, Bangalore (IN); Joshy John, Bangalore (IN); Herbert Chidsey Roberts, III, Simpsonville, SC (US)

(73) Assignee: GENERAL ELECTRIC COMPANY, Schenectady, NY (US)

(21) Appl. No.: 13/489,798

(22) Filed: Jun. 6, 2012

(51) Int. Cl. F01D 5/18; F02C 7/12

(52) U.S. Cl. 60/806; 416/96 R; 416/1

(57) ABSTRACT

A turbomachine bucket assembly includes a rotor member including a body having a center portion and an outer edge portion joined by a web. The rotor member includes one or more cooling fluid conduit having a dimension, and an inlet arranged at the outer edge. A plurality of blades are provided on the rotor member and mechanically linked to the outer edge. Each of the plurality of blades includes an internal cooling passage that is fluidly connected to the one or more cooling fluid conduits. A cooling fluid control element is provided at each of the one or more cooling fluid conduits. The cooling fluid control element is configured and disposed to adjust the dimension of the one or more cooling fluid conduits to alter fluid flow into the plurality of blades.

### BACKGROUND OF THE INVENTION

The subject matter disclosed herein relates to the art of turbomachines and, more particularly, to a bucket assembly for a turbomachine.

In a turbomachine, air in passed into an inlet of a compressor. The air is passed through various stages of the compressor to form a compressed airflow. A portion of the compressed airflow is passed to a combustion assembly and another portion of the compressed airflow is passed to a turbine portion and used for cooling. In the combustion assembly, the compressed airflow is mixed with fuel and combusted to form a high temperature gas stream and exhaust gases. The high temperature gas stream is channeled to the turbine portion via a transition piece. The transition piece guides the high temperature gas stream toward a hot gas path of the turbine portion. The high temperature gas stream expands through various stages of the turbine portion converting thermal energy to mechanical energy that rotates a turbine shaft. The turbine portion may be used in a variety of applications including providing power to a pump, an electrical generator, a vehicle, or the like.

### BRIEF DESCRIPTION OF THE INVENTION

According to one aspect of the exemplary embodiment, a turbomachine bucket assembly includes a rotor member including a body having a center portion and an outer edge portion joined by a web. The rotor member includes one or more cooling fluid conduits having a dimension, and an inlet arranged at the outer edge. A plurality of turbine blades are provided on the rotor member and mechanically linked to the outer edge. Each of the plurality of blades includes an internal cooling passage that is fluidly connected to the one or more cooling fluid conduits. A cooling fluid control element is provided at each of the one or more cooling fluid conduits. The cooling fluid control element is configured and disposed to adjust the dimension of the one or more cooling fluid conduits to alter fluid flow into the plurality of blades.

According to another aspect of the exemplary embodiment, a turbomachine includes a compressor portion, a turbine portion mechanically linked to the compressor portion, a combustor assembly fluidly connected to the compressor portion and the turbine portion, and a turbomachine bucket assembly arranged in the turbine portion. The turbomachine bucket assembly includes a rotor member having a body including a center portion and an outer edge portion joined by a web. The rotor member includes one or more cooling fluid conduits having a dimension, and an inlet arranged at the outer edge. A plurality of blades is provided on the rotor member and mechanically linked to the outer edge. Each of the plurality of blades includes an internal cooling passage that is fluidly connected to the one or more cooling fluid conduits. A cooling fluid control element is provided at each of the one or more cooling fluid conduits. The cooling fluid control element is configured and disposed to adjust the dimension of the one or more cooling fluid conduits to alter fluid flow into the plurality of blades.

According to yet another aspect of the exemplary embodiment, a method of cooling a turbomachine bucket assembly arranged within a turbomachine includes determining a desired temperature profile at the turbomachine bucket assembly, detecting an actual temperature profile at the turbomachine bucket assembly, comparing the desired temperature profile with the actual temperature of the cooling fluid, and signaling a cooling fluid control element provided on the bucket assembly to adjust a flow rate of the cooling fluid if the actual temperature profile differs from the desired temperature profile more than a desired amount.

These and other advantages and features will become more apparent from the following description taken in conjunction with the drawings.

### BRIEF DESCRIPTION OF DRAWINGS

The subject matter, which is regarded as the invention, is particularly pointed out and distinctly claimed in the claims at the conclusion of the specification. The foregoing and other features, and advantages of the invention are apparent from the following detailed description taken in conjunction with the accompanying drawings in which:

FIG. 1 is a schematic view of a turbomachine including a turbine portion having a bucket assembly in accordance with an exemplary embodiment;

FIG. 2 is a partial cross-sectional view of the turbine portion of FIG. 1;

FIG. 3 is a partial cross-sectional perspective view of a bucket assembly having a cooling fluid control element in accordance with an aspect of the exemplary embodiment;

FIG. 4 is a partial cross-sectional perspective view of a bucket assembly having a cooling fluid control element in accordance with another aspect of the exemplary embodiment;

FIG. 5. is a block diagram illustrating a controller coupled to a cooling fluid control element and sensors in accordance with an aspect of the exemplary embodiment; and

FIG. 6 is a block diagram illustrating a method of cooling a bucket assembly in accordance with an exemplary embodiment.

The detailed description explains embodiments of the invention, together with advantages and features, by way of example with reference to the drawings.

### DETAILED DESCRIPTION OF THE INVENTION

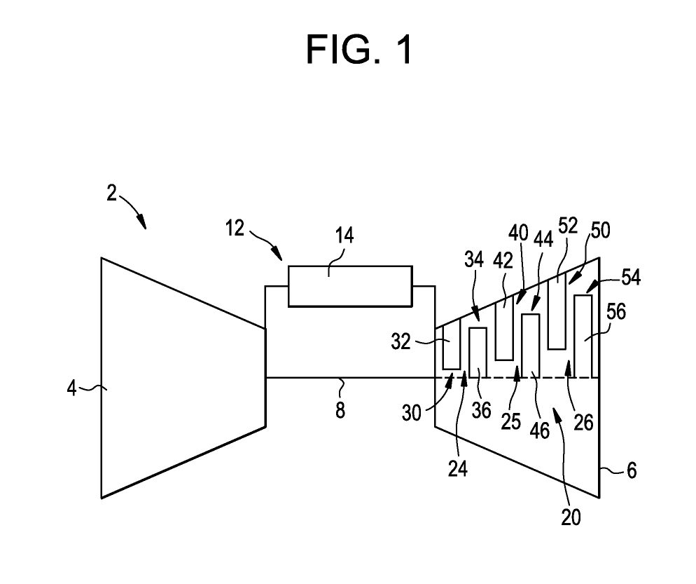

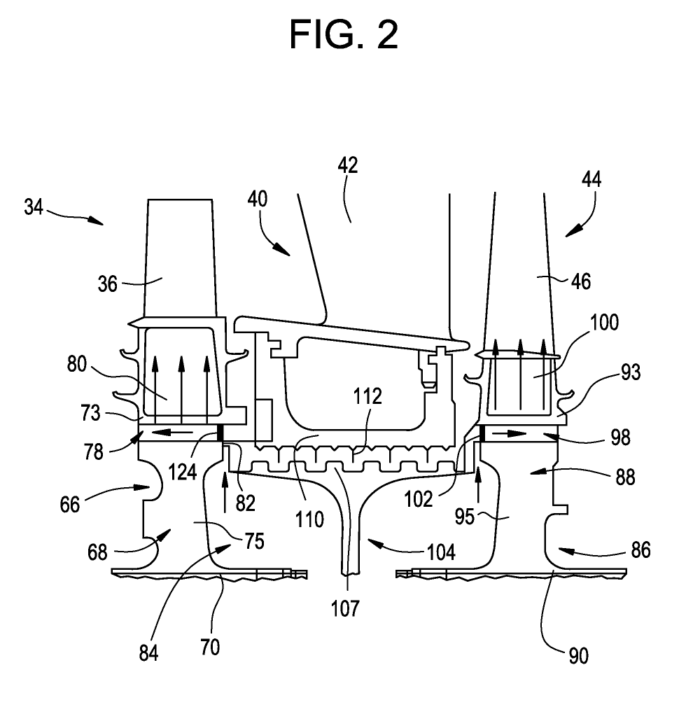

With reference to FIGS. 1 and 2, a turbomachine in accordance with an exemplary embodiment is indicated generally at 2. Turbomachine 2 includes a compressor portion 4 mechanically linked to a turbine portion 6 through a common compressor/turbine shaft 8. Compressor portion 4 is also fluidly connected to turbine portion 6 through a combustor assembly 12. Combustor assembly 14 includes a plurality of combustors, one of which is indicated at 14. Combustors 14 are generally arranged in a can-annular array about turbomachine 2. However other arrangements of combustors may also be employed.

Turbine portion 6 includes a plurality of turbine stages 20. In the exemplary embodiment shown, turbine stages 20 include a first stage 24, a second stage 25, and a third stage 26. While shown as including three stages, it should be understood that the number of stages may vary. First stage 24 includes a first nozzle assembly 30 having a first plurality of nozzles or vanes 32, and a first bucket assembly 34 having a first plurality of buckets or blades 36. Second stage 25 includes a second nozzle assembly 40 having a second plurality of nozzle or vanes 42, and a second bucket assembly 44 having a second plurality of buckets or blades 46. Third stage 26 includes a third nozzle assembly 50 having a third plurality of nozzles or vanes 52, and a third bucket assembly 54 having a third plurality of buckets or blades 56.

First bucket assembly 34 also includes a rotor member 66 that supports the first plurality of blades 36. Rotor member 66 includes a rotor body 68 having a center portion 70 and an outer edge portion 73 that are joined through a web 75. Rotor member 66 includes a cooling fluid conduit 78 that is positioned at outer edge portion 73 and fluidically connected to an internal cooling passage 80 provided on blade 36. It should be understood that rotor member 66 may include a single cooling fluid conduit 78 associated with each of the first plurality of blades 36 or may include multiple cooling fluid conduits 78 associated with respective ones of the first plurality of blades 36. In either case, cooling fluid conduit 78 includes an inlet 82 that is exposed to a wheel space 84 of turbine portion 6.

Second bucket assembly 44 includes a rotor member 86 that supports the second plurality of blades 46. Rotor member 86 includes a rotor body 88 having a center portion 90 and an outer edge portion 93 that are joined through a web 95. Rotor member 86 includes a cooling fluid conduit 98 that is arranged at outer edge portion 93 and fluidically connected to an internal cooling passage 100 provided on blade 46. Cooling fluid conduit 98 includes an inlet 102 that is exposed to wheel space 84 of turbine portion 6. Turbine portion 6 also includes a wheel member 104 arranged between rotor member 66 and rotor member 86. Wheel member 104 includes a sealing structure 107 that is configured and disposed to limit hot gases flowing along a hot gas path (not separately labeled) from entering wheel space 84. Sealing structure 107 is spaced from a plurality of shroud members 110 associated with each of the second plurality of vanes 42. Each shroud member 110 includes sealing elements 112 that cooperate with sealing structure 107 to limit hot gas ingestion to wheel space 84.

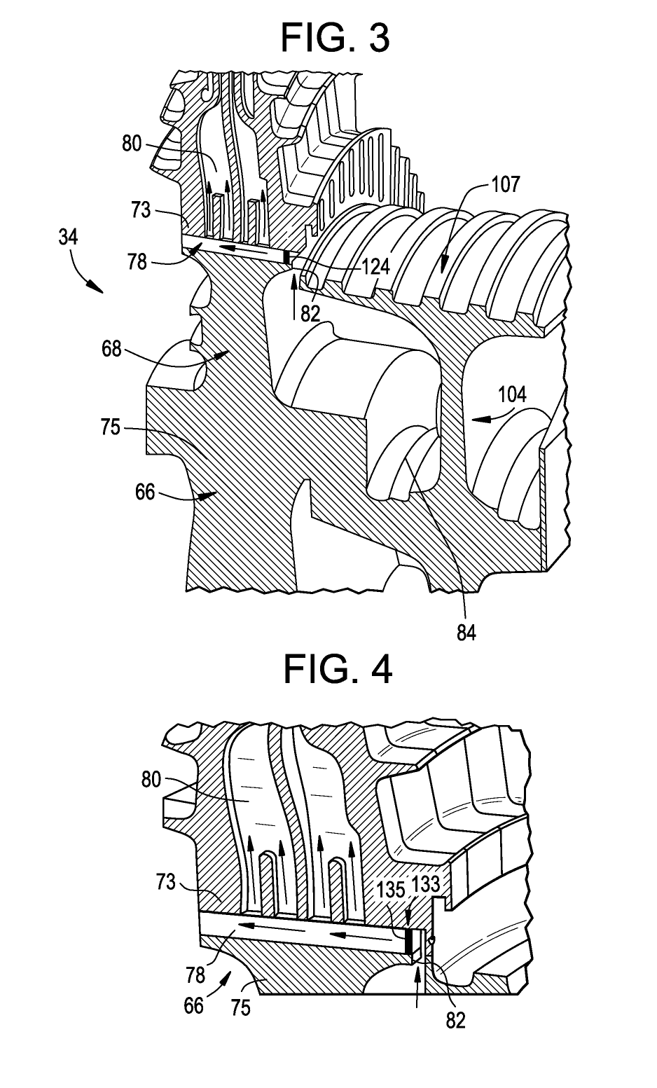

In accordance with one aspect of the exemplary embodiment illustrated in FIG. 3, rotor member 66 includes a cooling fluid control element 124 arranged at inlet 82 of cooling fluid conduit 78. Cooling fluid control element 124 takes the form of a passive control element 126 that changes characteristics based on, for example, perceived temperature changes. Passive control element 126 may be a shaped metal alloy (SMA) element, bi-metallic element or the like. Cooling fluid control element 124 adjusts a dimension of cooling fluid conduit 78 to alter cooling fluid flow into one or more of the first plurality of blades 36. More specifically, as temperatures at inlet 82 increases, passive control element 126 responds by opening or enlarging a dimension of cooling fluid conduit 78 to increase cooling fluid flow into internal passage 80. As temperatures at inlet 82 drop, less cooling fluid is required and cooling fluid control element 126 responds by constricting the dimension of cooling fluid conduit 78 to reduce the amount of cooling flow passing into internal cooling passage 80. At this point it should be understood that cooling fluid conduit 98 may also be provided with a cooling fluid control element 126.

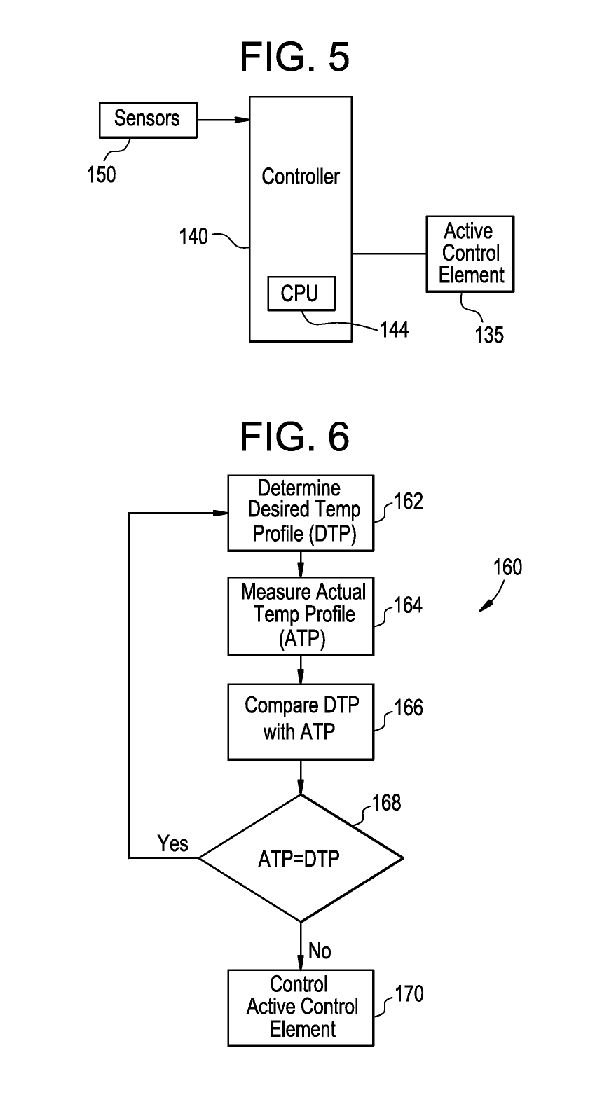

FIG. 4 illustrates a cooling fluid control element 133 in accordance with another aspect of the exemplary embodiment. Cooling fluid control element 133 takes the form of an active control element 135 that changes characteristics based on a received control input. Active control element 135 may take the form of a shaped metal alloy (SMA) actuator, a micro electro-mechanical system (MEMS) actuator, a micro optical mechanical actuator (MOM), a micro optical electro-mechanical (MOEM) actuator, a piezoelectric actuator and the like. Active control element 135 is operatively coupled to a controller 140 having a central processing unit (CPU) 144 as shown in FIG. 5.

Controller 140 signals active control element 135 to change a dimension of cooling fluid conduit 78 to adjust cooling fluid flow into one or more of the first plurality of blades 36. Controller 140 is also coupled to one or more sensors 150 arranged within turbomachine 2. Sensors 150 may include one or more of a micro-electromechanical system (MEMS) sensor, a piezoelectric sensor, a transducer, and the like. Sensors 150 provide input to controller 140 of one or more operating parameters of turbomachine 2. The one or more operating parameters may include a temperature profile of the cooling fluid passing into rotor member 66, wheelspace temperature, hot gas path temperature and the like. Controller 140 determines a desired temperature profile for the first plurality of blades 36 and, if conditioning is warranted, signals active control element 135 to establish a desired flow rate of cooling fluid into cooling flow conduit 78 as will be detailed more fully below.

A method of operating turbomachine 2 and, more specifically, controlling a temperature profile of the first plurality of blades 36 is indicated at 160 in FIG. 6. Controller 140 determines a desired temperature profile (DTP) of the first plurality of blades 36 as shown in block 162. Controller 140 employs inputs from sensors 150 and a stored algorithm to select the DTP. Controller 140 also measures an actual temperature profile (ATP) of the first plurality of blades 36 as shown in block 164 such as by direct measurement using thermocouple based instrumentation (not shown) A thermocouple (not shown) may be inserted directly into a gas stream of interest to provide direct measurement data. Alternatively, the ATP may be determined by measuring a related temperature value at a remote location and using a transfer function to determine the ATP. The ATP may also be determined though a more complex transfer function having guiding input(s) being either a single input or a combination of two or more measured values. The measured values may include local or remote thermocouple based temperatures, one or more gas pressure value(s) or the shaft rotational speed value.

Controller 140 compares the DTP with the ATP in block 166. If the DTP is the same as or within a desired range, for example within 5%, of the ATP no action is taken as seen on block 168. If, however it is determined in block 168 that the DTP does not equal or fall within the desired range of the ATP, controller 140 signals active control element 135 to adjust the dimension of cooling fluid conduit 78 to control an amount of cooling fluid flowing into the first plurality of blades 36 to achieve the DTP as seen in block 170. Adjusting the dimension of cooling fluid conduit 78 includes both increasing the dimension of cooling flow conduit 78 to increase cooling fluid flow into the first plurality of blades 36 and decreasing the dimension of cooling fluid conduit 78 to reduce the amount of cooling fluid flow passing into the first plurality of blades 36 depending on the magnitude (positive or negative) of the difference between the ATP and the DTP.

At this point it should be understood that the exemplary embodiment provide a system and method for controlling fluid flow into a bucket assembly to maintain a desired temperature profile of a plurality of blades to protect turbomachine components. It should be understood that while shown and described as being formed as part a rotor member for one bucket assembly; each bucket assembly of the turbine portion may be provided with a similar cooling system. It should also be understood that the control element may be mounted directly into one or more of the cooling fluid conduits or provided as part of one or more fluid injectors mounted to the rotor wheel. Also, it should be appreciated that while various examples of passive control elements, active control elements, and sensors were described and claimed in connection with the exemplary embodiment, other types of passive control elements, active control elements and sensors may also be employed.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. A turbomachine bucket assembly comprising:
a rotor member including a body having a center portion and an outer edge portion joined by a web, the rotor member including one or more cooling fluid conduits having a dimension, and an inlet arranged at the outer edge portion;
a plurality of blades provided on the rotor member and mechanically linked to the outer edge portion, each of the plurality of blades including an internal cooling passage that is fluidly connected to the one or more cooling fluid conduits; and
a cooling fluid control element provided at each of the one or more cooling fluid conduits, the cooling fluid control element being configured and disposed to adjust the dimension of the one or more cooling fluid conduits to alter fluid flow into the plurality of blades.

2. The turbomachine bucket assembly according to claim 1, wherein the cooling fluid control element comprises a passive control element configured and disposed to adjust the dimension of the one or more cooling fluid conduits based on a temperature at the rotor member.

3. The turbomachine bucket assembly according to claim 2, wherein the passive cooling fluid control element comprises a shaped metal alloy (SMA) element.

4. The turbomachine bucket assembly according to claim 1, wherein the cooling fluid control element comprises an active control element that is configured and disposed to selectively adjust the dimension of the one or more cooling fluid conduits.

5. The turbomachine bucket assembly according to claim 4, wherein the active control element comprises a shaped metal alloy (SMA) actuator.

6. The turbomachine bucket assembly according to claim 4, wherein the active control element comprises a micro electro-mechanical system (MEMS) actuator.

7. The turbomachine bucket assembly according to claim 4, wherein the active control element comprises one of a micro optical-mechanical (MOM) actuator and a micro optical-electro-mechanical (MOEM) actuator.

8. The turbomachine bucket assembly according to claim 4, wherein the active control element comprises a piezoelectric actuator.

9. The turbomachine bucket assembly according to claim 4, further comprising: a controller operatively connected to the active control element, the controller being configured and disposed to signal the active control element to adjust the dimension of the one or more cooling fluid conduits.

10. The turbomachine bucket assembly according to claim 1, wherein the cooling fluid control element is mounted at the inlet of the one or more cooling fluid conduits.

11. A turbomachine comprising:
a compressor portion;
a turbine portion mechanically linked to the compressor portion;
a combustor assembly fluidly connected to the compressor portion and the turbine portion; and
a bucket assembly arranged in the turbine portion, the bucket assembly comprising:
a rotor member including a body having a center portion and an outer edge portion joined by a web, the rotor member including one or more cooling fluid conduits having a dimension, and an inlet arranged at the outer edge portion;
a plurality of blades provided on the rotor member and mechanically linked to the outer edge portion, each of the plurality of blades including an internal cooling passage that is fluidly connected to the one or more cooling fluid conduits; and
a cooling fluid control element provided at each of the one or more cooling fluid conduits, the cooling fluid control element being configured and disposed to adjust the dimension of the one or more cooling fluid conduits to alter fluid flow into the plurality of blades.

12. The turbomachine according to claim 11, wherein the cooling fluid control element is a passive control element configured and disposed to adjust the dimension of the one or more cooling fluid conduits based on a temperature at the rotor member.

13. The turbomachine according to claim 12, wherein the passive control element comprises a shaped metal alloy (SMA) element.

14. The turbomachine according to claim 11, wherein the cooling fluid control element comprises an active control element that is configured and disposed to selectively adjust the dimension of the one or more cooling fluid conduits.

15. The turbomachine according to claim 14, wherein the active control element comprises one of a shaped metal alloy (SMA) actuator, a micro electro-mechanical system (MEMS) actuator, a micro optical-mechanical (MOM) actuator, a micro optical-electro-mechanical (MOEM) actuator, and a piezoelectric actuator.

16. The turbomachine according to claim 14, further comprising: a controller operatively connected to the active control element, the controller being configured and disposed to signal the active control element to adjust the dimension of the one or more cooling fluid conduits.

17. A method of cooling a turbomachine bucket assembly for arranged within a turbomachine, the method comprising:
determining a desired temperature profile at the turbomachine bucket assembly;
detecting an actual temperature profile at the turbomachine bucket assembly;
comparing the desired temperature profile with the actual temperature profile; and
signaling a cooling fluid control element provided on the bucket assembly to adjust a flow rate of the cooling fluid if the actual temperature profile differs from the desired temperature profile more than a desired amount.

18. The method of claim 17, further comprising: sensing an operating parameter of the turbomachine.

19. The method of claim 18, wherein determining the desired temperature profile includes evaluating the operating parameter of the turbomachine.

20. The method of claim 17, wherein signaling the cooling fluid control element comprises signaling one of a shaped metal alloy (SMA) actuator, a micro electro-mechanical system (MEMS) actuator, a micro optical-mechanical (MOM) actuator, a micro optical-electro-mechanical (MOEM) actuator, and a piezoelectric actuator.
